(19) United States
(12) Patent Application Publication
(10) Pub. No.: US 2016/0125171 A1
(43) Pub. Date: May 5, 2016

(54) SYSTEMS AND METHODS FOR MANAGING CLINICAL TRIALS

(71) Applicants: Gerald E. Finken, Fargo, ND (US); Kristina Schlecht, Hopkins, MN (US)

(72) Inventors: Gerald E. Finken, Fargo, ND (US); Kristina Schlecht, Hopkins, MN (US)

(21) Appl. No.: 14/994,543

(22) Filed: Jan. 13, 2016

Related U.S. Application Data
(63) Continuation of application No. 11/199,658, filed on Aug. 9, 2005, now abandoned.

(51) Int. Cl. G06F 19/00; G06F 17/30

(52) U.S. Cl. CPC G06F 19/363; G06F 17/30424; G06F 17/30598

(57) ABSTRACT

Systems and methods for managing, analyzing, and evaluating clinical trials. Clinical trial data collection, management, review, and analysis may be performed independent of the clinical trial. A clinical trial manager may have a study review and management application and a clinical trial database. The study review and management application may have a protocol selecting engine, a data collection engine, and a data analysis engine. The data collection engine may have a communication routine and documentation routine for collecting data and documenting the data in the clinical trial database. The data analysis engine may have a categorization routine and analysis routine for categorizing and analyzing the data collected by the data collection engine. The clinical trial manager may be accessible via a user interface.

### CROSS-REFERENCE TO RELATED APPLICATIONS

This application claims the benefit of U.S. non-provisional patent application Ser. No. 11/199,658, filed on Aug. 9, 2005, entitled “Systems and Methods for Managing Clinical Trials” the disclosures of which are hereby incorporated by reference herein in their entirety.

### FIELD OF THE INVENTION

The present disclosure relates to the field of clinical trial research. Particularly, the present disclosure relates to the collection, management, review and analysis of clinical trial data. More particularly, the present disclosure relates to independent and real-time data collection, management, review, and analysis of clinical trial data.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Medical innovations, from new drugs to medical devices, are often researched and tested using a series of clinical trials. Many trials require more than one phase of testing that take several years and cost considerable amounts of money to perform. One reason for the length and cost of clinical trials is the need to independently review and submit data and documentation for a clinical trial. The review and submission cannot traditionally be performed until all information is collected, documented, and analyzed.

Typically, a clinical trial or study is funded by a sponsor, such as a private company, medical or research institution, federal agency, or by any entity established by a collaboration of such groups. The sponsor may employ one or more clinical investigators or research assistants to oversee administration of and/or monitor the study at one or more investigation sites. Each investigation site may include a number of study participants.

There is a need in the art for systems and methods that can more efficiently collect, review, and analyze clinical trial data. More particularly, there is a need for systems and methods for performing an independent review and certification of clinical trial data in real-time while the clinical trial is ongoing.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

The present disclosure, in one embodiment, relates to a computer-implemented data collection and analysis method for managing clinical trial data while the trial is ongoing. The method may include communicating with a clinical trial participant to evaluate the participant's trial progress or experience, wherein communicating with the participant includes asking the participant one or more questions to elicit a response; recording data received from communicating with the clinical trial participant, the data comprising the response elicited; associating the data with one or more study categories, the study categories related to one or more of study protocols, intervention data, compliance data, and demographic data; storing the data in a searchable database as non-transitory computer readable media; and comparing the data to one or more thresholds or one or more other data entries in the database. In some embodiments, the data may be retrieved from the database by searching the database for an associated study category. Communicating with a clinical trial participant may be conducted automatically using a communication routine in some embodiments, and communication may be conducted over a telephone, text message, email, or video communication. The comparing step may be performed independently by an entity that is not administering the clinical trial to participants. The comparing step may be performed using at least one of a computer-based trending tool, a computer-based site-to-site variation tool, and a computer-based outlier tool. In some embodiments, the method may further include using a computer-based query tool to determine that more information is needed from a source, generate a query configured to obtain the needed information from the source, send the query to the source over a wired or wireless network to elicit a response, receive data from the source, the data comprising the response elicited, associate the data received from the source with the data received from communicating with the clinical trial participant, and store the data in the database as non-transitory computer readable media. In some embodiments, determining that more information is needed from a source may include identifying an inconsistency in the data or identifying an empty data field. Further, the source may be a participant in some embodiments.

The present disclosure, in another embodiment, relates to a computer-implemented system for data collection and analysis during a clinical trial. The system may include a data collection engine for collecting data from clinical trial participants, a data analysis engine for analyzing data collected by the data collection engine, a searchable clinical trial database storing the data collected by the data collecting engine and historical clinical trial data, and a user interface for accessing the data collection engine, data analysis engine, and clinical trial database. In some embodiments, the data collection engine may have a communication routine that facilitates communicating with the clinical trial participants and a documentation routine that documents the communications with the clinical trial participants. Further, the data analysis engine may have a categorization routine that categorizes data collection by the data collection engine into one or more study markers and an analysis routine that analyzes the data. The system may also include a protocol selecting engine for selecting one or more study protocols to be used for a clinical trial and one or more review protocols to review the clinical trial. In some embodiments, user access may be controlled at the user interface based on usernames and passwords, and different types of users may be provided with different levels of access. The documentation routine may include a question-to-data-field linking tool and/or a keyword search tool in some embodiments. The analysis routine may compare the data to other data stored in the database and to one or more thresholds. The analysis routine may further determine whether a clinical trial should be certified. The analysis routine may include an alert tool to generate an alert if the analysis routine determines a health or safety risk, that intervention is needed, or that a study protocol should be changed, in some embodiments. The analysis routine may analyze the data using at least one of a computer-based trending tool, a computer-based site-to-site variation tool, and a computer-based outlier tool.

The present disclosure, in another embodiment, relates to a computer-implemented data collection and analysis method for managing clinical trial data while a clinical trial is ongoing. The method may include automatically contacting a study participant at a scheduled time; asking the study participant one or more questions; determining whether the one or more questions have been answered adequately, and if not, asking the study participant one or more follow up questions; determining whether all scheduled study participants have been contacted, and if not, contacting a next study participant; recording data received from contacting the clinical trial participant, the data comprising the participant's answers to the one or more questions; associating the data with one or more study categories, the study categories related to one or more of study protocols, intervention data, compliance data, and demographic data; storing the data in a searchable database as non-transitory computer readable media; and comparing the data to one or more thresholds or one or more other data entries in the database. In some embodiments, contacting a study participant may be performed using telephone, text, email, or video communication. Further, in some embodiments, the comparing step may be performed independently by an entity that is not administering the clinical trial to participants. The comparison step may be performed using at least one of a computer-based trending tool, a computer-based site-to-site variation tool, and a computer-based outlier tool

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1 is a flow chart illustrating a method according to one embodiment of the present disclosure.

FIG. 2 is a schematic diagram of a system according to one embodiment of the present disclosure.

FIG. 3 is a flow chart illustrating a communication routine according to one embodiment of the present disclosure.

### DETAILED DESCRIPTION

The present disclosure relates to novel and advantageous systems and methods for managing, analyzing, and evaluating clinical trials. Particularly, the present disclosure relates to novel and advantageous systems and methods for clinical trial data collection and organization in a database, as well as various comparisons and other analyses of the data. The systems and methods of the present disclosure may allow for data collection, management, and review that is independent of the clinical trials. In addition, the systems and methods of the present disclosure may allow for ongoing data analysis and evaluation during and after clinical trials.

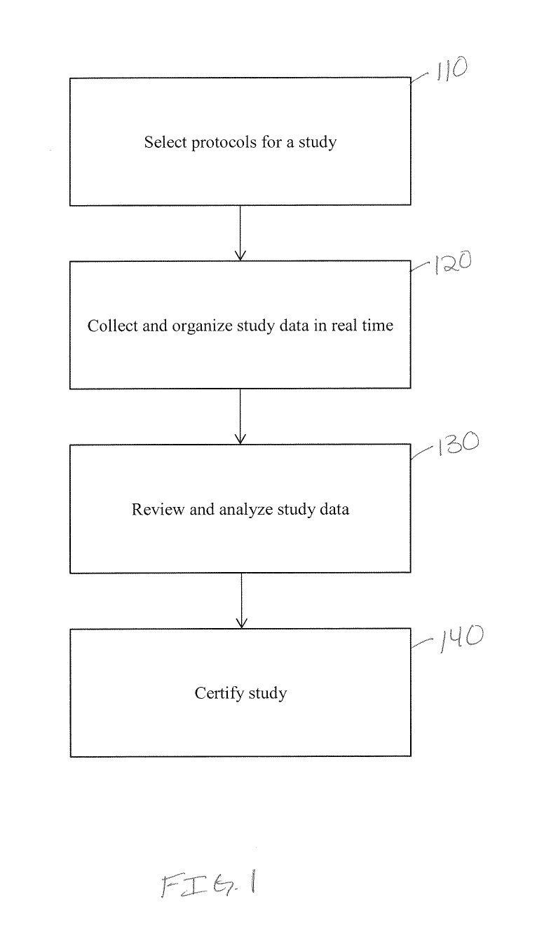

In some embodiments, the present disclosure may relate to a method for managing a clinical trial or study. As shown in FIG. 1, systems of the present disclosure may assist with selecting protocols for a study 110, collecting and organizing study data in real time 120, reviewing and analyzing the study data 130, and certifying the study 140. In some embodiments, the study data may be reviewed and analyzed 130, and even certified 140, while the study is still ongoing, as the study data may be collected in real time.

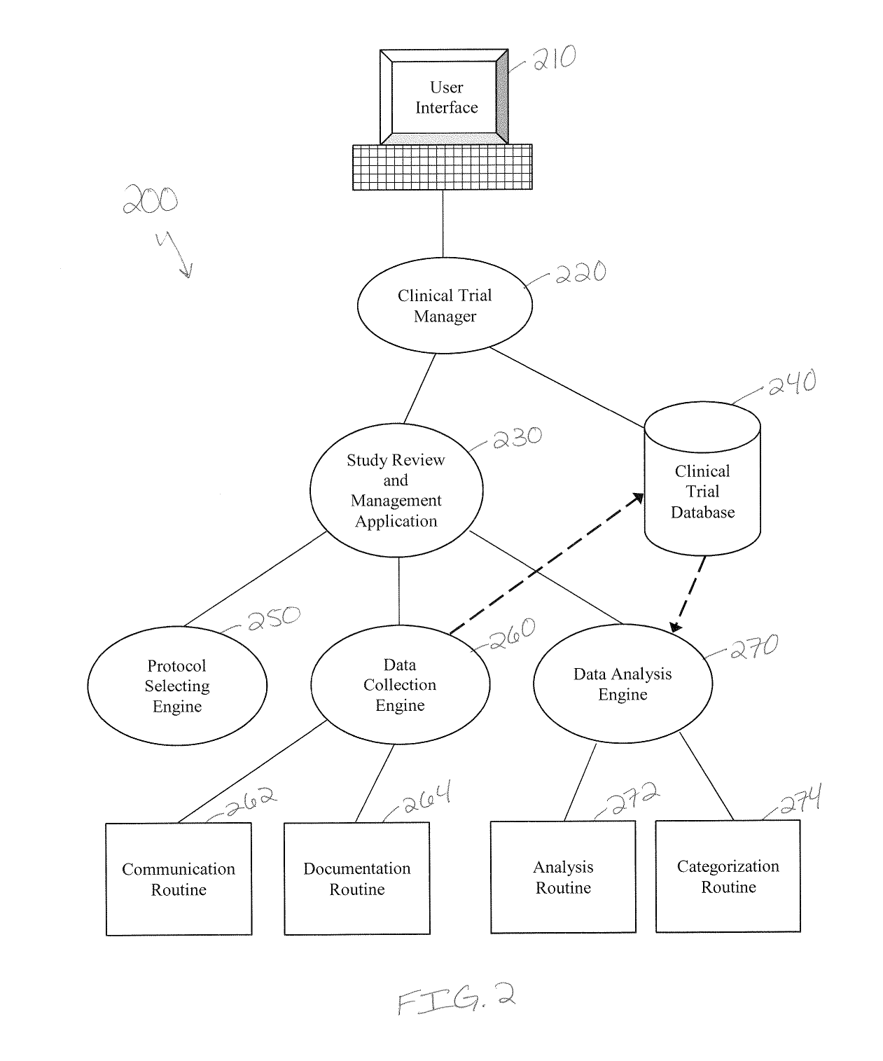

In some embodiments, the present disclosure may relate to a system 200 for managing clinical trials. As shown in FIG. 2, a clinical trial manager 220 may have or communicate with a study review and management application 230 in communication with a clinical trial database 240. In some embodiments, the clinical trial manager 220 may include various tools allowing for automatic, partially automatic, and/or manual processes. In some embodiments, the clinical trial manager may be or include a program or series of programs or applications.

The clinical trial manager 220 may perform a number of automated actions in some embodiments. For example, the clinical trial manager 220 may have one or more automatic communication routines for communicating with participants, and/or may have one or more automatic analysis routines for analyzing data collected from participants. In this way, the clinical trial manager 220 may provide for independent data collection, analysis, and review for a clinical trial. In some embodiments, the clinical trial manager 220 may independently collect and/or analyze data. In other embodiments, one or more users may use the clinical trial manager 220 to independently collect and/or analyze data. For example, a Clinical Trials Research Pharmacist may be an independent third party responsible for collecting, reviewing, and analyzing data through the use of the clinical trial manager 220. Clinical Trials Research Pharmacists may independently track participant communication, ensure necessary documentation, facilitate electronic storage of documentation, and facilitate electronic transfer of patient reports to clinical investigators, for example. Other independent third parties may use the clinical trial manager 220 to collect, review, and/or analyze data. In some embodiments, users connected with the study, such as participants, clinical investigators, study coordinators, sponsors, or others may use the clinical trial manager 220 to collect, review, and/or analyze data. The clinical trial manager 220 may be located locally or remotely. The terms “patient” and “participant” may be used herein interchangeably.

The clinical trial manager 220 may allow for the planning or setup of a new clinical trial, data collection and data management during a clinical trial, and real-time data review and analysis during and after a clinical trial. Through real-time data collection and analysis, the certification process for a study may be accelerated or simplified. Real-time data collection and analysis may also allow for timely correction of errors or missing data among study sites, or determining when a change in protocol is needed. The clinical trial manager 220 may help to ensure application of uniform or consistent protocols across a study. The clinical trial manager may perform various analyses such as determining trends, determining thresholds, comparing data to thresholds, determining outliers, determining real-time safety concerns, or other analyses. Real-time data collection and analysis may allow this information to be determined while a study is ongoing.

The clinical trial database 240 may be accessible by the clinical trial manger 220. The database 240 may store various information related to one or more clinical trial studies, such as but not limited to participant and patient data, enrollment data, study data, or user data for example. The database 240 may be located locally or remotely. The database 240 may comprise multiple databases in some embodiments. For example, in some embodiments, the database 240 may include a separate database or data storage space for each clinical trial study. In some embodiments, the database 240 may include information from various sources. For example, the database 240 may have information input by a user or otherwise collected by the study review and management application 230. The database 240 may additionally or alternatively include information obtained from one or more outside sources. For example, the database 240 may access publicly available or other clinical trial information from past clinical trials. The database 240 may obtain information from additional sources in other embodiments. Information in the database 240 may be categorized in some embodiments, as discussed more fully below. The database 240 may be searchable in some embodiments, based on search parameters such as, for example, study markers, patient or participant name, study name, study protocols, product data, study compliance rates, study intervention rates, reported side effects, study certifications, time or date of data entry, or other search parameters.

The study review and management application 230 may facilitate management of one or more clinical trials and/or independent review of one or more clinical trials. The study review and management application 230 may have a protocol selecting engine 250, a data collection engine 260, and a data analysis engine 270, each of which is discussed more fully below. The study review and management application 230 may be accessible from a user interface 210 in some embodiments. From the user interface 210, a user may access the various processes and applications of the study review and management application 230, including the protocol selecting engine 250, the data collection engine 260, and the data analysis engine 270. A user may additionally have the ability to access the database 240 via the user interface 210. In some embodiments, the user interface 210 may control access to the processes, applications, and information by requiring a user login, such as a username and password, from a user. The user interface 210 may be accessed via a desktop computer, laptop computer, tablet, smartphone, or other computing device.

### Protocol Selecting Engine

The study review and management application 230 may have a protocol selecting engine 250, which may be accessible via the user interface 210 in some embodiments. The protocol selecting engine 250 may be used to establish or identify one or more protocols for a particular clinical study. A study protocol may have attributes related to or defining a particular clinical trial study. For example, a study protocol may contain a particular drug name used in the study, a gender or age requirement for the participants of the study, a number of participants, a particular direction given to participants, a study sponsor, study guidelines, start and end dates, a research associate, type of participant communication, frequency of participant communication, or others. The protocol selecting engine 250 may be used to select one or more review protocols for independently reviewing the study. The protocol selecting engine 250 may allow for automated, partially automated, or manual control over study protocol attributes even for large clinical trial studies encompassing a number of investigation sites at different locations.

The protocol selecting engine 250 may automatically select or allow a user to select protocols to conduct a study or to evaluate a study. The protocol selecting engine 250 may allow a user to input custom study protocol attributes, or may allow a user to select study protocol attributes from a drop down list, for example. In some embodiments, the protocol selecting engine 250 may be used to search study data in the database 240 based on one or more study protocol attributes. The protocol selecting engine 250 may further be used to select one or more protocols or study protocol attributes of a previous or ongoing study, and apply the selected protocol(s) or study protocol attribute(s) to a new study. The protocol selecting engine 250 may, in some embodiments, determine and/or display trends in prior or ongoing study protocol attributes. The protocol selecting engine 250 may further select or allow a user to select new study protocols attribute based on such trends. The protocol selecting engine 250 may additionally or alternatively allow a user to view, edit, delete, or archive protocols. A user may wish to edit or delete protocols for a study where issues are identified during the course of the study. In some embodiments, the protocol selecting engine 250 may automatically update or delete protocols based on data collected by the data collection engine 260 during the course of the study. In some embodiments, the protocol selecting engine 250 may allow a user to enter notes or other information regarding a particular study. In some embodiments, study protocol attributes may be established for all participants, groups of participants (such as a placebo group, for example), or individual participants. In some embodiments, protocols may be dynamic and may automatically adapt as the study progresses. For example, where a participant consistently follows instructions, a protocol may update allowing for less frequent communication with the participant or for automated, rather than live communication. Conversely, where a participant has one or more interventions (occurrences where instructions were not followed, unexpected symptoms occurred, or otherwise) a protocol may update automatically to designate more frequent live communication.

### Data Collection Engine

The study review and management application 230 may have a data collection engine 260, which may be accessible via the user interface 210 in some embodiments. In some embodiments, the data collection engine 260 may make or facilitate contact with or between one or more sources in order to accumulate data related to a clinical trial. The data collection engine 260 may communicate with or facilitate communication between study participants, Clinical Trials Research Pharmacists, research assistants, clinical investigators, study coordinators, sponsors, physicians, organizations, or others. In some embodiments, the data collection engine 260 may comprise one or more routines, such as a communication routine 262, and a documentation routine 264.

The communication routine 262 may initiate and facilitate communication between various sources. The communication routine 262 may be initiated automatically, semi-automatically, and/or through user input. The data collection engine 260 may include more than one communication routine 262 in some embodiments. In some embodiments, the communication routine 262 may facilitate communication with study participations. For example, the communication routine 262 may allow the clinical trial manager 220 or a user to contact study participants in order to inquire about and track their progress in the study. Contact, such as phone calls, may be automated or live. In some embodiments, a user may contact study participants by way of the clinical trial manager 220 and communication routine 262. Further, in some embodiments, participants may use the communication routine to communicate with the clinical trial manager 220.

The communication routine 262 may use one or more methods of communication. In various embodiments, communication may include, but is not limited to, phone calls, emails, text messages, video communication, pager notices, remote sensors, web page or application interfaces, or any other suitable method. In some embodiments, the communication may be unidirectional and not require a response. For example, a participant may receive a text message or other communication indicating a change in instructions or directions or a reminder to dose. In other embodiments, a communication may require a response. The communication routine 262 may repeatedly attempt communication in the same, or alternative methods, until a communication response is obtained.

One benefit of embodiments of the present disclosure is the ability to independently collect supporting, contradicting, and/or additional data about a study or its participants in order to analyze, assess quality control, spot inconsistency and safety issues, and make real-time adjustments as needed. The clinical trial manager 220, unlike an investigator or researcher who is conducting the study, may be an unbiased third party or may be operated by an unbiased third party such as a Clinical Trials Research Pharmacist. A study participant may disclose more complete or additional information to a third party like the clinical trial manager 220 than they would to a research assistant. This may be due to a lack of communication skills by the research assistant, because the participant forgot certain instructions, or even because the participant forgot to mention or was reluctant to mention to the research assistant certain symptoms being experienced.

Communication between the clinical trial manager 220 and a study participant may be automatically or manually initiated by the clinical trial manager, a user, or a participant. The clinical trial manager 220 may use the contact information and preferences provided to complete scheduled communication, and unscheduled communication, as warranted. The clinical trial manager 220 may record all communication attempts where no contact was established and store the date and time of attempt. In some embodiments, notes on attempted contacts may also be made and stored. The clinical trial manager 220 or user may also reschedule the communication for a later date and time, in some embodiments. If the call is successful, the date and time may be recorded and the appropriate data collection may begin. Any data collection may be sent to the documentation routine 264 to be documented and stored in the clinical trial database 240.

Communication may have a timeline for achieving contact. That is, in some embodiments, a study protocol may require a communication to be completed within a limited time period. For example, whether using automated or live communication, a study protocol may require contact to be completed within three business days of a scheduled communication. If no communication is established by the end of the third day, the system may record the breach of protocol, attempt an alternate means of communication, change protocol guidelines, or any other suitable remedy may be implemented. Similarly, unscheduled communications and urgent communications may have a timeline. After the data analysis engine 270, discussed below, determines the need for an unscheduled urgent communication, for example, a timeline to contact one or more sources may be established. For example, if the data analysis engine 270 determines that a participant's safety or health is at risk, it may institute one or more communication methods via the communication routine 262 in an attempt to establish contact by the end of the day. If no contact is made, more drastic emergency measures may be taken.

Upon establishing communication with a participant, the clinical trial manager 220 or a user may make automated or live inquiries. The system or user may administer a survey, query, or display a series of data fields to one or more study participants. In some embodiments, questions may be generated by the clinical trial manager 220 or a user. In other embodiments, questions may be generated by the data analysis engine 270, discussed below. Inquiry may be focused on the required fields in one or more documentation protocols, discussed below. When the query is based on pre-established documentation, the question may be linked to the document, such that each answer corresponds to one data field. For example, a question that asks when medication was taken may be linked to the data input field on the document that requests the same information, making documentation quick and efficient. In some embodiments, the answers may be open ended, allowing the participant to answer freely. For example, a question may ask, “When did you take your medication?” to which a user may answer, “8:09 am.” In some embodiments, the answer may be recorded by a user such as a Clinical Trials Research Pharmacist, or the clinical trial manager 220 may automatically record and interpret the answer. In other embodiments, the answers may be selected from a pre-specified list of options. For example, a question may ask, “Did you take your medication 1) in the morning, 2) at noon, 3) in the afternoon, or 4) in the evening?” to which a participant may reply with one or more options, either verbally, by text, or otherwise.

In various embodiments, the communication routine 262 may include the option to send push notifications to a participant via a cell phone or mobile device. In some embodiments, the receiver of the push notification may have the option to respond. In some embodiments, the responses may include, but are not limited to, true or false. The participant may respond ‘true’ and the information may be time-stamped and sent to the documentation routine. In one embodiment, if the user responds ‘false,’ the communication routine 262 may resend the message until a true response is registered. For example, a message may be displayed asking the participant if they have taken their medication for the day. If the user responds ‘false,’ the communication routine may resend the message every hour until the user responds ‘true.’

In various embodiments, the communication routine 262 may collect information from patient sensors. Examples of patient sensors may include, but are not limited to, glucose and insulin monitors, pacemakers, electronic pill containers, or other patient sensors.

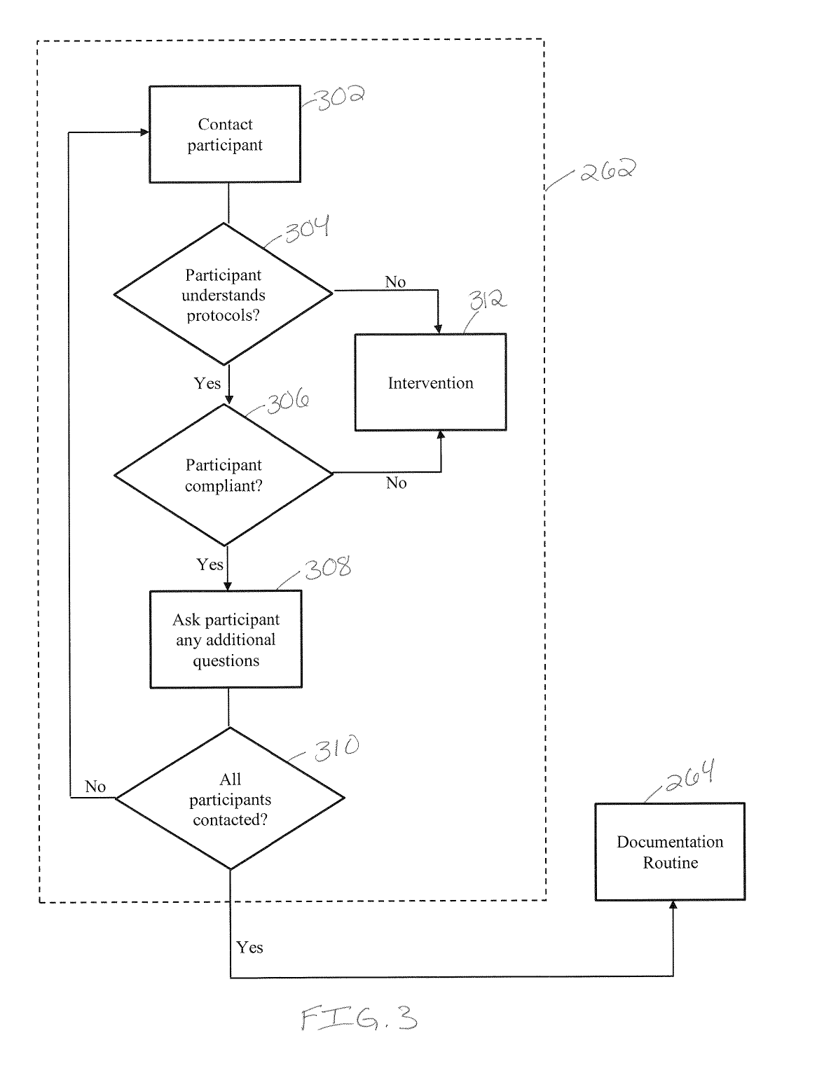

In some embodiments, the communication routine 262 or a user may contact participants and may ask one or more objective and/or subjective questions. FIG. 3 shows a flow chart illustrating one embodiment of a communication routine 262. As shown in FIG. 3, the communication routine 262 may contact a participant 302 to ask questions. In various embodiments, the questions may be related to the participant's understanding 304 and/or compliance 306 with study protocols. In some embodiments, questions may be related to objective or subjective patient experiences, such as side effects or mood. If the participant understands the protocol adequately and is in compliance or has substantially answered the question, the method may continue with any further questions 308 until all questions have been completed. If all questions have been answered, the method may determine if all intended patients have been contacted 310. If the answer is no, the communication routine may contact the next patient and begin the process again with the new patient. If the answer is yes, the communication routine 262 may stop and all data may be sent to the documentation routine 264. It may be understood that in other embodiments, data may be sent to the documentation routine 264 at any time.

If understanding, compliance, or experiences are negative for any question, the communication routine 262 may, either automatically or manually, temporarily exit the question chain. If a negative experience or observation is detected, an intervention 312 may be recorded, data may be sent to the documentation routine 264, and the data analysis engine 270 may determine which steps to take next. Further steps may include asking additional questions, making a note to follow-up, or initiating an alternative method of communication. For example, an automated clinical trial manager 220 that detects a participant having undesirable side effects may continue with any other questions and make a note to have the clinical trial manager 220, a user, or other individual follow up, may send the information to the data analysis engine 270 to compare to thresholds and make a determination, or may end the communication and request a user or other individual establish contact. Any other suitable responses may also be instituted.

The clinical trial manager 220, a user, and/or a participant may input study related data by sending one or more pieces of information via the communication routine 262. In some embodiments, patient specific values may be entered, such as dosing amount, weight, duration of sleep, symptoms, diet, activity levels, or others, into a web based spreadsheet. It is understood that any number of users may enter data in any suitable method. All data may be sent to the documentation routine 264, in various embodiments.

The documentation routine 264 may use one or more features or functions to document a communication. The documentation routine 264 may take all information collected and fill out one or more data fields. In some embodiments, data fields may be filled out in one or more documents simultaneously. The documentation routine 264 may use one or more tools to complete documentation. In some embodiments, the tools may include, but are not limited to, a question-to-data-field linking tool, a keyword search tool, and a manual entry tool. In other embodiments, more, fewer, or different tools may be used to fill out documentation.

The question-to-data-field linking tool may automatically fill in documentation based on the association or link the data field has with a particular inquiry. For example, a question, asked by the communication routine 262, about the participant's activity level may be linked to a particular data field. The participant's answer may be automatically inserted into the appropriate data field.

The keyword search tool may fill in documentation by performing a keyword search of the data collected by the communication routine 262. For example, data fields discussing symptoms may search the communication data for any mention of key words such as “bruising,” “headache,” or “swelling” and insert those words into the data field.

In various embodiments, one or more data fields may be filled in manually using the manual entry tool. The clinical trial manager 220 or a user may fill in the data fields during a communication with a participant. In addition, the clinical trial manager 220 or a user may review the data collected by the communication routine 262 and fill in the appropriate data fields. The clinical trial manager 220 or user may then make note of what data fields have missing or incomplete responses. The manual entry tool may also allow the clinical trial manager 220 or a user to delete, edit, or review the data obtained. All edits and deletions to data may, in various embodiments, be recorded and documented.

The documentation routine 264 may create or update one or more records, reports, charts, or other documents for each communication. In addition, the documentation routine 264 may receive, scan, or upload one or more documents. In various embodiments, one or more documents may be linked with one or more communications. For example, the communication routine 262 may ask a question relevant to each data field in a document. The document may also be tagged or linked with the on-going study, with the participant's chart or file, and/or with one or more study protocols or study markers, discussed below, for ease of searching. The documentation routine 264 may use various documentation protocols or forms, such as a contact record or patient counseling report.

A contact record may be a standard template used to document and customize data fields. The contact record may contain data including, but not limited to, company name, study protocol number, user or clinical trial manager 220, date, time, patient ID, reference IDs, visit number, scheduled or unscheduled communication designation, next scheduled communication, study medication dose, concomitant medication list, device issues, IVRS reporting, dosing schedule, missed doses, notes for follow-up, request for researcher review, request for live review, request for record to be transmitted to one or more sources, on-hand medication amounts, request for medication returns, and any other relevant record information. The contact record may also have options for automatic or manual transmission, such as email or fax, to the study site, sponsor, government agency, or other entity.

A patient counseling report may be used when instructions or directions change or when further information is warranted from a participant. Patient counseling reports may, in some embodiments, also be used to follow-up, report, or seek clarification. Patient counseling reports may have information including, but not limited to, protocol number, text instructions or text instruction fields, status of interventions made, medication usage, correct dose, timing of dose, missed dose, compliance, injection technique (with text instructions), storage (with text instructions), questions about ancillary supplies, and any other questions about dosing or equipment. The patient counseling report may also include information about the equipment used including manufacturer, equipment ID, date of last equipment inspection, etc. In some embodiments, the patient counseling report may also include patient specific information: requests such as a phone number or contact means, a request to establish contact at certain or reoccurring points during the day or week, and/or a request to establish contact to report a symptom or reaction. For example, communication may be established by the clinical trial manager 220, user, or participant when side effects such as nausea, hypoglycemia, hyperglycemia, bruising, headaches, changes in blood pressure or vision, or any other symptoms occur or fail to remedy. Patient counseling reports may be used to discuss concomitant medications, supply levels, information about study medication or study protocols, lifestyle information, quality of life information, or any other miscellaneous information or concerns.

Documentation may require review, editing, and/or finalization. In some embodiments, a user or other individual may be required to review documentation, complete one or more necessary fields, place an electronic signature and date on document, complete patient chart notes as necessary, complete scanning of original documents and store with patient charts if needed. In other embodiments, one or more actions may be done by automated or partially automated instructions.

A document or data record may be assigned a status automatically or manually, such as a quality control status, a finalized status, or other status. The quality control status may indicate whether documentation review or corrective action is required. In some embodiments, documentation may be reviewed before being finalized. A user may select documentation of communication from a cue for quality control review. In some embodiments, communication initiated or facilitated by a user may not be reviewed by the same user. A user, upon selection of the communication, may be presented with all associated documentation. After analysis and review, the user may re-contact the participant, make any edits, or leave comments in the selected documents. The user may assign a new corrective action status, such as normal, urgent, none necessary, or any other appropriate status. In various embodiments, a communication flagged with a corrective action status of anything other than “none necessary” may be re-cued for review from another user.

The corrective action may be designated normal or urgent. In various embodiments, the clinical trial manager 220 or a user may complete a normal corrective action. A user who is working or on-call may receive an alert to follow up on an urgent corrective action. It is to be understood that any sufficient method to remedy a quality control status may be used. A finalized status may indicate that all data fields are complete, no follow-up or corrective actions are needed, and the document has been reviewed by at least one user.

One particular advantage of the systems and methods of the present disclosure is the ability to maintain direct communication with all patients enrolled in a study. In this way, information may be collected from all patients and aggregated for analysis in real time. In contrast, conventional clinical trial management may provide for clinical investigators or others who may each be in direct communication with a local group of patients, and sponsors, trial managers, or others who may collect data from clinical investigators to aggregate it for analysis. Thus, the systems and methods of the present disclosure may provide for more efficient and current data aggregation and analysis.

All data associated with the communication, review, and corrective measures may be associated with the study and participant report and then stored in the clinical trial database 240.

### Data Analysis Engine

The study review and management application 230 may have a data analysis engine 270, which may be accessible via the user interface 210 in some embodiments. One of the many advantages of the systems and methods of the present disclosure may be the ability to categorize and analyze, in real time, data collected from a clinical trial. As seen in FIG. 2, the data analysis engine 270 may be comprised of one or more routines. In various embodiments, the routines may include, but are not limited to a categorization routine 272 and an analysis routine 274.

In various embodiments, the categorization routine 272 may categorize data inputs by study markers, making the data more readily searchable. Study markers may be general, high level categories, or more specific, sub-categories. In various embodiments, the categorization routine 272 may use one or more sources of information to automatically categorize the data. In various embodiments, categorization may use data including, but not limited to, study protocol attributes, client intake documentation, files generated in the documentation routine 264, any other suitable source, or any combination thereof, to categorize the data by study markers. Study markers may generally relate to established protocols, study protocol attributes, and/or to characteristics of particular study data or participants.

In some embodiments, study markers used to categorize a study may be defining characteristics of the study, for example. For example, a study generally may be conducted to test the efficacy of drug X on heart function and may be associated with the study marker, “drug X effects on heart function.” One or more keywords or phrases may be associated with the study marker for ease of searching. For example, “drug X” and “heart function” may be key phrases associated with the study marker. Data related to a study may be associated with several study markers. For example, drug X may, in effect, thin the blood of a patient to ease blood flow into the heart. Also, the intended benefit of drug X may be to those people with high blood pressure. Therefore, the study may also be categorized and searchable as blood thinners, drugs for high blood pressure, high blood pressure, etc. In some embodiments, the study marker may be a drug type, for example, but not limited to, antidepressants, painkillers, steroids, decongestants, stimulants, etc. In some embodiments, the study marker may be the clinical trial phase, including but not limited to, Phase I, Phase II, Phase III, and Phase IV. In some embodiments, the study marker may be the clinical site including, but not limited to, site A, site B, site C, city X, city Y, and city Z, for example. In some embodiments, the study may be defined by the diagnosis to be treated, including but not limited to, cancer, heart disease, high cholesterol, high blood pressure, depression, AIDS, or any other disease or symptom. It is understood that a study marker may be, and/or a study may be categorized by, one or more data inputs.

Study markers may also include more detailed markers so as to identify more study or participant specific information. For example, in a study where patients may be given varying amounts of the drug to test for safe consumption levels, study markers may be defined by the varying dose rates that one or more patients received or by the demographics of the patients who received each dose. As another example, a study marker may be a unique identification number assigned to a particular study participant. In some embodiments, one or more study markers may relate to compliance data, such as how well clinical trial instructions have been followed. In some embodiments, compliance data may relate to, but are not limited to, when drugs were taken, how much was taken, where the drugs were stored, how much of a drug a patient has on hand, how often the drug has been taken, or any other relevant information.

In some embodiments, one or more study markers may relate to intervention data, such as problems that arise within a clinical trial. For example, an intervention may be recorded when data shows a patient is in some way non-compliant. Non-compliant interventions may take one or more forms, including, but not limited to, misunderstanding the directions for taking a compound, failing to re-order medication when necessary, failing to follow diet or exercise instructions, or any other failure to follow or administer clinical instructions correctly and consistently. Other interventions may be recorded for data that was unpredicted. An unpredicted intervention, in some embodiments, may include a negative clinical outcome unrelated to instructions. For example, in one study testing a drug, there may be one or more interventions recorded for side effects, including but not limited to, headache, nausea, blurred vision, dizziness, fainting, bleeding, bruising, or any other potential side effect. In another embodiment, an intervention may be recorded when a patient moves from the area, voluntarily leaves the study, or becomes incapacitated in some way, resulting in the study having one or more patients with incomplete study related data.

Interventions may be ranked according to their severity, and study markers or keywords thus may encompass severity levels of interventions. For example, an intervention related to dosing of medication may be denoted “incorrect dose,” “too small of dose,” “too large of dose,” “failure to dose,” or any other applicable word or phrase. In some embodiments, the intervention ranking may be numerical. For example, an intervention with a ranking of “one” may be a very minor mistake or misunderstanding, and may not affect the study's quality control or certification. An intervention with a ranking of “ten” may be very severe and may require immediate or emergency action. It is understood that any intervention ranking system may be used.

In some embodiments, study markers may relate to demographic data of study participants. In some embodiments, demographic data may be objective data that includes, but is not limited to, diet, activity level, hobbies, gender, height, weight, disease or stage of disease, family history, lifestyle, ethnicity, domicile, medical history, career, sleep patterns, BMI, fat percentage, muscle percentage, age, or any other demographic data. Demographic data may be subjective data that includes, but is not limited to, mood, quality of life, approval statistics, or any other subjective information that is obtained. Demographic data may also be used to identify the study and may include, for example, study length, study location(s), study dates, or follow-up information received after a study finishes. Demographic data may or may not be a study protocol attribute for the on-going study, but may be useful in setting up thresholds or protocols in future studies.

All categorized data may be stored in the clinical trial database 240 to be later searched or used as historical or reference data.

The analysis routine 274 may analyze data collected by the data collection engine 260 and compare it against one or more thresholds, or other data entries, in order to analyze the data, determine if more information is needed, determine if alerts are warranted, determine whether data and documentation should be submitted for study certification, and/or determine whether a study should be certified. The data analysis routine 274 can analyze the data collected against data from various sources, such as independent data, other clinical trial data, data from one or more historical or reference clinical trials, government or organization compliance data, and/or any other information from any other source. The data analysis routine 274 may use one or more tools for analyzing data.

The analysis routine 274 may have a trending tool. The trending tool may analyze how interventions, compliance, moods, or other trends change over time within a study. The trending tool may show trends across a particular study, at a particular study site, or across participants. For example, compliance data may be aggregated across one or more study locations to view trends within the study, across one or more studies to show trends within similar studies or to show trends across all studies, in some embodiments. One or more trends may be categorized as a study marker by the categorization routine 272.

The analysis routine 274 may have a site-to-site variation tool. The site-to-site variation tool may indicate if data at a study site fall outside the acceptable standard deviation for the clinical trial as a whole. Once a study site is indicated as falling outside an acceptable range, the data may be further analyzed automatically by the clinical trial manager 220 or manually by a user. For example, analysis may determine that instructions to participants were worded differently at the study site, causing increased confusion and thus increased numbers of interventions compared to other sites.

The analysis routine 274 may have an outlier tool. The outlier tool may indicate if there is one or more data points within a study that do not fit a trend. The outlier tool may indicate a data point that, while not cause for concern, is abnormal. For example, in a weight loss study, the outlier tool may identify one or more participants who experience thirty percent weight loss over a given time period where all other participants experienced less than twenty percent weight loss. In other embodiments, the data point indicated may be cause for concern. Once a data point is identified by the outlier tool, the data may be further analyzed automatically by the clinical trial manager 220 or manually by a user.

The analysis routine 274 may have a query tool. Where additional information is needed, the query tool may generate a query to obtain information. In some embodiments, the query tool may generate a query to be used by the communication routine 262 to obtain information. In some embodiments, the analysis routine 274 may note unreported information. For example, a data field from a report that was filled in by some participants but not others may cause a query to be generated. In another example, one or more participants may report a side effect not explicitly asked about in the communication, such as a lesion. The analysis routine 274 may note that five percent of participants reported the presence of a lesion, and the query tool may be used to discover if one or more other participants also have a lesion that has gone unreported. In various embodiments, the analysis routine 274 may note data inconsistency and generate a query to clarify. For example, one or more reports may indicate dosing information where one study site reported 50 mg doses while all other sites reported 500 mg doses. A query may be generated to discover, for example, if a direction or instruction was changed at one site, if a mistake in dosing was made, or if a mistake in data entry was made. The query may be sent, using the communication routine 262, to the clinical trial database 240, a participant, a user, and/or any other suitable source.

The analysis routine 274 may have an alert tool. The alert tool may generate an alert when analyzed information causes concern. Non-exhaustive examples of information that may generate an alert include, but are not limited to, data outside thresholds established by the study protocols, data inconsistent with historical or reference studies, data that is an outlier, or data that indicates an emergency symptom or action was reported. An alert may also be generated where there is a strong correlation in similar category historical studies between one or more reported data fields and a dangerous result. For example, a study evaluating an anti-depressant medication may have documentation indicating a symptom, such as insomnia. If historical data indicates a correlation between participants on anti-depressant medication who experienced insomnia and suicide, the alert tool may generate an alert. In some embodiments, the alert tool may generate an alert where it is determined, by the trending tool for example, that a group of participants is having a higher intervention rate than others. An alert may allow re-education or other corrective action to be taken in real time before the study is complete. An alert may be sent, using the communication routine 262, to the clinical investigator, a sponsor, a user, and/or any other suitable source.

One particular advantage of embodiments of the present disclosure is the ability to analyze and independently review the study in real time. The real-time analysis allows the generation of queries and alerts which can be used to gain more information and put one or more sources on notice when warranted. The real-time analysis and response may allow for timely responses to particular issues, which may improve the data obtained and increase the likelihood of study certification. For example, in the study mentioned above that had differently worded instructions, a query sent to the clinical investigator of that site requesting clarification may notice the confusion, which may then be addressed. In addition, the alert tool may put one or more sources on notice of the increased number of interventions at that site. The reason for the increase may be discovered and adjusted while the study is in progress.

### User Interface

A user may access the clinical trial manager 220 via a user interface 210. The user interface 210 may be accessed via a desktop computer, laptop computer, tablet, smartphone, or other computing device. From the user interface 210, a user may access the clinical trial manager 220, including the study review and management application 230, clinical trial database 240, protocol selecting engine 250, data collection engine 260, and data analysis engine 270. The various applications, processes, programs, routines, tools, and databases of the clinical trial manager 220 may be located locally or remotely from the user interface 210. That is, a particular application may be located on a local hard drive with the user interface 210, or may be accessed over a wired or wireless connection such as the Internet, for example. Embodiments of the present disclosure may be able to interface with other databases and systems in accordance with 21 CFR Part 11 (i.e., IVR, barcode capabilities, RFID systems, etc.). As is well known in the art, the user interface 210 may include one or more tabs, prompts, or pages for interacting with the clinical trial manager 220. Tabs, prompts, or pages may include, but are not limited to sign in, study set-up, on-going study protocols, study participant records, quality control, alerts, communications, documentation, analysis, and database search. The user interface 210 may, in some embodiments, include automated phone calls, emails, text messages, or other suitable communication methods.

The first time a user attempts to access the clinical trial manager 220, the user may be asked to register with the system. The registration process may include collecting data from the user, including unique user data (passwords, etc.) that may be used by the clinical trial manager 220 to generate a unique membership, profile, or user account for example. Examples of the type of data that may be collected include, but are not limited to, name, address, physician name, physician contact information, email, phone number, study ID, study participant ID, desired username, desired password, a fingerprint and/or a retinal scan. In some embodiments, a study participant ID may be permanently assigned to a specific user, which may allow the system to track study related participant data (for example a participant's general compliance, common symptoms, etc.) in one or more studies. In some embodiments, there may be one or more user types including but not limited to, Clinical Trials Research Pharmacist, physician, study participant, clinical investigator, site monitor, subject monitor, sponsor, government entity, or any other suitable user type.

In some embodiments, a user may be prompted to sign in to the clinical trial manager 220 before the user is granted access to the system. The user may be asked to provide information including, but not limited to, first name, last name, email address, employee information, patient information, a username, and/or password, for example. Other information may include the company information (name, address, contact information, and other notes), protocol information, clinical site information, or other suitable information. In some embodiments, the user may enter a password and username on a mobile application or website. In other embodiments, the user may say or dial their name, ID, and/or password over the phone. It may be understood that any suitable methods of communication and identification the user may be used. The clinical trial manager 220 may allow only an authenticated user to access the system and data associated with that user's information. The clinical trial manager 220 may make note of which user type is accessing the system and allow access to one or more user access areas. The clinical trial manager 220 may allow multiple simultaneous users.

In some embodiments, at least some users may have limited access through the user interface 210. In some embodiments, a user may be granted access to all levels lower than the access level assigned to them. For example, a user assigned Level A access may have access to Levels A, B, and C, but a user assigned Level B access may have access to only Levels B and C. In some embodiments, the areas of access may be read-only, depending on the user.

A user with Level A access may be a system administrator. In some embodiments, a Level A access may allow a user to add, update, and delete individuals, change passwords and access levels, add, update, and archive information, and run invoicing reports. A user with Level A access may also have access to Levels B and C.

A Level B access may be given to clinical investigators. In some embodiments, a Level B access may allow a user to add, update, or archive various study protocol attributes, add protocol specific reference information, run patient outcome reports, authorize protocol specific access to other users, assign quality control release authorization to other users, receive scheduled communication alerts, receive alerts to document communication, and receive unscheduled or emergency call alerts. Level B users may also be granted access to Level C.

A Level C access may have limited functionality, in some embodiments. For example, a user with Level C access may be able to make scheduled contact with participants, complete documentation of communication, make unscheduled contacts as warranted, access participant information, enter participant chart notes, scan original documentation if needed, and assign quality control status and protocols to scheduled and unscheduled patient communications or documentation. A user may also review, analyze, and release a communication/documentation with relation to quality control, or assign it to be reviewed by another user. In other examples, a patient or participant may have limited access to initiate scheduled or unscheduled communication. During these communications, the patient may enter objective or subjective responses to study protocols specific to the patient, make additional notes as warranted, or update some patient information.

A Level D access may be strictly limited in functionality. A user with Level D access may be able to view company information, study protocol information, processing protocol information, site information, patient contact information, and/or any other suitable information. A user with Level D access may have read-only access in some embodiments.

In various embodiments, a Level Q access may be responsible for a study's quality assurances. A user with Level Q access may assign corrective action status to all documentation (including patient chart notes), assign quality assurance final release status to patient charts, generate quality assurance reports, and access any other quality control or assurance measure.

In some embodiments, a Level X may be used with limited operations and functions to help set-up a study or study site. A user with Level X access may add, update, and archive site information, enroll or deactivate patients, assign patients to an automated routine and/or one or more live Clinical Trials Research Pharmacists, update patient contact information, and complete electronic storage of scanned original source documents if needed.

Users with the necessary access levels may enroll participants into a study. A user, accessing the enroll patient page, may enroll a participant by: selecting one or more study protocols to be associated with the participant and/or entering the participant's number, participant's first name, participant's phone number, participant's time zone, participant's desired method of contact, and participant's desired time to be contacted. In some embodiments, enrollment automatically adds a participant to one or more study protocols and creates a participant's electronic chart within the clinical trial database 240. In other embodiments, the study protocol assignment and chart creation may be done manually. Participant information may be updated as needed.

### Searching the Database

As mentioned, the clinical trial database 240 may be searchable. The clinical trial manager 220 may search the clinical trial database 240 automatically and/or a user may search the database for current or past studies using one or more search parameters, such as study markers, clinical investigator name, participant name, patient identifier, study name, study protocols, product data, study compliance rates, study intervention rates, reported side effects, study certifications, time or date of entry, or other search parameters. The searchable clinical trial database 240 may allow users to tailor an upcoming study by identifying desirable protocol attributes and thresholds and/or by tailoring the study to better understand study results. For example, a user may search the clinical trial database 240 to find protocol attributes used in one or more studies where participants experienced beneficial outcomes, such as good quality of life, few side effects, or a low level of interventions. In another example, a user looking to conduct a study of a cancer drug on women may search the clinical trial database 240 for cancer drug studies conducted on both men and women, but then refine the results to see what outcomes the women of the study experienced. The searchable clinical trial database 240 may also allow users to tailor study protocols to help identify safety and certification standards in on-going studies. A user conducting an independent review of a study testing drug X may select all studies that test drug X, and incorporate aspects of the study data into its review. For example, in the on-going study of drug X, alerts may be generated or upgraded to urgent if a patient reports bruising where a search of the clinical trial database 240 reveals that past studies testing drug X found a severe complication correlated with bruising. The searchable clinical trial database 240 may allow a user to search for interventions or other issues identified in similar studies in an effort to prepare for or avoid such interventions or issues in a new study. For example, in developing a study of a drug that requires refrigeration, a database search may reveal that patients in other studies of refrigerated drugs experienced difficulties keeping the drug refrigerated at times, such as during travel. In an effort to avoid the refrigeration issues, the new study may be developed with a protocol for providing patients with travel-size coolers.

A study marker may, in some embodiments, be generally searchable on its own. That is, a user accessing the clinical trial database 240 may be able to search for a study marker. One or more cases may share a study marker. For example, a user who searches ‘anti-virals’ may return one or more clinical studies related to anti-viral drugs. The first study marker selected may, in some embodiments, act as a general search. In one embodiment, a second study marker may act as a broadening search term. For example, a user may define a first study marker as ‘anti-bacterial’ which may return one or more clinical studies related to anti-bacterial drugs. The user may then select a second study marker of ‘anti-fungal’ which may return one or more clinical studies related to anti-fungal drugs. The resulting search may be a relatively larger list of clinical trials related to both anti-bacterial or anti-fungal drugs. In another embodiment, a second study marker may act as a limiting search term. For example, a user may define a study marker as ‘Phase I’ which may return one or more clinical studies conducted in Phase I. The user may then select a study marker of ‘high cholesterol’ resulting in a narrowing of the Phase I list to only clinical studies in Phase I that relate to high cholesterol. In effect, any subsequent study markers may act as study limitations, in some embodiments. It is to be understood that any number of study markers may be configured to conduct a search that narrows or broadens, or any combination thereof.

In some embodiments, particular narrow study markers, such as study or participant specific study markers, may be searchable at a second tier search, after one or more broader study markers are selected at a first tier search. For example, a user may search for the study marker, ‘breast cancer,’ and the clinical trial database 240 may return a list of one or more clinical trials that relate to breast cancer. One or more narrower markers may be selected which may narrow the list to the user's specific interest. For example, a user may select a narrow study marker of ‘women under 40,’ thereby narrowing the list of clinical trials who had study participants under 40 years of age as a requirement. The user may also select a narrow study marker of ‘injection dosing,’ thereby narrowing the list further, resulting in a list of breast cancer related clinical trials conducted on participants under 40 that were dosed with drugs via an injection method. Such narrow study or participant specific study markers may include study markers related to compliance data, intervention data, demographic data, or other data.

For any study marker, a user, in some embodiments, may select zero, one, or more expansion options based on similarity. Markers may have one or more levels of similarity with other markers. In some embodiments, the similarity may be based on a level of similarity and may include, but are not limited to, level 1, level 2, level 3, and level 4. Level 1 may be an “exact match” option, and may expand the search only to the same premise, thereby limiting the search to an exact, or nearly exact match. Level 2 may be a “substantially similar” option, and may expand the search to substantially similar characteristics of the search term. Level 3 may be a “similar” expansion option, and may expand the search to characteristics that share similar properties. Level 4 may be a “slightly similar” expansion option, and may expand the search to any and all characteristics that share the slightest similar properties. In various embodiments, level 1, or the exact match, may be the default “similarity” search. For example, a study marker search for the drug ‘Cardura’ may, in level 1, return a list of clinical studies using the brand name drug Cardura, an alpha-blocker vasodilator used to treat high blood pressure. A user that selects the level 2 option may expand the list to include doxazosin, the generic name of the same drug. A user that selects the level 3 option may expand the list to further include other brand name and generic alpha-blocking vasodilators, such as Minipress and prazosin, Hytrin and terazosin, respectively. A user that selects the level 4 option may further expand the list to include all vasodilatation drugs even if they do not use the same mechanism (alpha-blocking) to achieve the effect.

For purposes of this disclosure, any system described herein may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, a system or any portion thereof may be a personal computer (e.g., desktop or laptop), tablet computer, mobile device (e.g., personal digital assistant (PDA) or smart phone), server (e.g., blade server or rack server), a network storage device, or any other suitable device or combination of devices and may vary in size, shape, performance, functionality, and price. A system may include random access memory (RAM), one or more processing resources such as a central processing unit (CPU) or hardware or software control logic, read-only memory (ROM), and/or other types of nonvolatile memory. Additional components of a system may include one or more disk drives or one or more mass storage devices, one or more network ports for communicating with external devices as well as various input and output (I/O) devices, such as a keyboard, a mouse, touchscreen and/or a video display. Mass storage devices may include, but are not limited to, a hard disk drive, floppy disk drive, CD-ROM drive, smart drive, flash drive, or other types of non-volatile data storage, a plurality of storage devices, or any combination of storage devices. A system may include what is referred to as a user interface, which may generally include a display, mouse or other cursor control device, keyboard, button, touchpad, touch screen, microphone, camera, video recorder, speaker, LED, light, joystick, switch, buzzer, bell, and/or other user input/output device for communicating with one or more users or for entering information into the system. Output devices may include any type of device for presenting information to a user, including but not limited to, a computer monitor, flat-screen display, or other visual display, a printer, and/or speakers or any other device for providing information in audio form, such as a telephone, a plurality of output devices, or any combination of output devices. A system may also include one or more buses operable to transmit communications between the various hardware components.

One or more programs or applications, such as a web browser, and/or other applications may be stored in one or more of the system data storage devices. Programs or applications may be loaded in part or in whole into a main memory or processor during execution by the processor. One or more processors may execute applications or programs to run systems or methods of the present disclosure, or portions thereof, stored as executable programs or program code in the memory, or received from the Internet or other network. Any commercial or freeware web browser or other application capable of retrieving content from a network and displaying pages or screens may be used. In some embodiments, a customized application may be used to access, display, and update information. In some embodiments, software applications such as BioOptronics, ClinPlus, Medidata, MedNet Solutions, Merge, OpenClinica, TargetHealth, or other applications or programs may be employed in the systems and methods described herein, and may perform one or more processes, routines, or other functions described with respect to the systems and methods of the present application.

Each element of a system described herein, including but not limited to the user interface, clinical trial manager, study review and management application, clinical trial database, protocol selecting engine, data collection engine, data analysis engine, communication routine, documentation routine, analysis routine, and categorization routine, may include hardware, software, or a combination of hardware and software. Hardware and software components of the present disclosure, as discussed herein, may be integral portions of a single computer or server or may be connected parts of a computer network. The hardware and software components may be located within a single location or, in other embodiments, portions of the hardware and software components may be divided among a plurality of locations and connected directly or through a global computer information network, such as the Internet.

As will be appreciated by one of skill in the art, the various embodiments of the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, middleware, microcode, hardware description languages, etc.), or an embodiment combining software and hardware aspects. Furthermore, embodiments of the present disclosure may take the form of a computer program product on a computer-readable medium or computer-readable storage medium, having computer-executable program code embodied in the medium, that define processes or methods described herein. A processor or processors may perform the necessary tasks defined by the computer-executable program code. Computer-executable program code for carrying out operations of embodiments of the present disclosure may be written in an object oriented, scripted or unscripted programming language such as Java, Perl, PHP, Visual Basic, Smalltalk, C++, or the like. However, the computer program code for carrying out operations of embodiments of the present disclosure may also be written in conventional procedural programming languages, such as the C programming language or similar programming languages. A code segment may represent a procedure, a function, a subprogram, a program, a routine, a subroutine, a module, an object, a software package, a class, or any combination of instructions, data structures, or program statements. A code segment may be coupled to another code segment or a hardware circuit by passing and/or receiving information, data, arguments, protocols, or memory contents. Information, arguments, protocols, data, etc. may be passed, forwarded, or transmitted via any suitable means including memory sharing, message passing, token passing, network transmission, etc.

In the context of this document, a computer readable medium may be any medium that can contain, store, communicate, or transport the program for use by or in connection with the systems disclosed herein. The computer-executable program code may be transmitted using any appropriate medium, including but not limited to the Internet, optical fiber cable, radio frequency (RF) signals or other wireless signals, or other mediums. The computer readable medium may be, for example but is not limited to, an electronic, magnetic, optical, electromagnetic, infrared, or semiconductor system, apparatus, or device. More specific examples of suitable computer readable medium include, but are not limited to, an electrical connection having one or more wires or a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device. Computer-readable media includes, but is not to be confused with, computer-readable storage medium, which is intended to cover all physical, non-transitory, or similar embodiments of computer-readable media.

Various embodiments of the present disclosure may be described herein with reference to flowchart illustrations and/or block diagrams of methods, apparatus (systems), and computer program products. It is understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks. Alternatively, computer program implemented steps or acts may be combined with operator or human implemented steps or acts in order to carry out an embodiment of the invention.

Additionally, although a flowchart may illustrate a method as a sequential process, many of the operations in the flowcharts illustrated herein can be performed in parallel or concurrently. In addition, the order of the method steps illustrated in a flowchart may be rearranged for some embodiments. Similarly, a method illustrated in a flow chart could have additional steps not included therein or fewer steps than those shown. A method step may correspond to a method, a function, a procedure, a subroutine, a subprogram, etc.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an ingredient or element may still actually contain such item as long as there is generally no measurable effect thereof.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

We claim:

1. A computer-implemented data collection and analysis method for managing clinical trial data, comprising, while the clinical trial is ongoing:
communicating with a clinical trial participant to evaluate the participant's trial progress or experience, wherein communicating with the participant comprises asking the participant one or more questions to elicit a response;
recording data received from communicating with the clinical trial participant, the data comprising the response elicited;
associating the data with one or more study categories, the study categories related to one or more of study protocols, intervention data, compliance data, and demographic data;
storing the data in a searchable database as non-transitory computer readable media; and
comparing the data to one or more thresholds or one or more other data entries in the database.

2. The method of claim 1, wherein the data may be retrieved from the database by searching the database for an associated study category.

3. The method of claim 1, wherein communicating with a clinical trial participant is conducted automatically using a communication routine.

4. The method of claim 3, wherein the communicating is conducted over telephone, text message, email, or video communication.

5. The method of claim 1, wherein the comparing step is performed independently by an entity that is not administering the clinical trial to participants.

6. The method of claim 1, wherein the comparing step is performed using at least one of a computer-based trending tool, a computer-based site-to-site variation tool, and a computer-based outlier tool.

7. The method of claim 1, further comprising, using a computer-based query tool:
determining that more information is needed from a source;
generating a query configured to obtain the needed information from the source; and
sending the query to the source over a wired or wireless network to elicit a response;
receiving data from the source, the data comprising the response elicited;
associating the data received from the source with the data received from communicating with the clinical trial participant; and
storing the data in the database as non-transitory computer readable media.

8. The method of claim 7, wherein determining that more information is needed from a source comprises identifying an inconsistency in the data.

9. The method of claim 7, wherein determining that more information is needed from a source comprises identifying an empty data field.

10. The method of claim 7, wherein the source is a participant.

11. A computer-implemented system for data collection and analysis during a clinical trial, comprising:
a data collection engine for collecting data from clinical trial participants, the data collection engine comprising:
a communication routine that facilitates communicating with the clinical trial participants; and
a documentation routine that documents the communications with the clinical trial participants;
a data analysis engine for analyzing data collected by the data collection engine, the data analysis engine comprising:
a categorization routine that categorizes data collected by the data collection engine into one or more study markers; and
an analysis routine that analyzes the data;
a searchable clinical trial database storing the data collected by the data collecting engine and historical clinical trial data; and
a user interface for accessing the data collection engine, data analysis engine, and clinical trial database.

12. The system of claim 11, further comprising a protocol selecting engine for selecting one or more study protocols to be used for a clinical trial and one or more review protocols to review the clinical trial.

13. The system of claim 11, wherein user access is controlled at the user interface based on usernames and passwords.

14. The system of claim 13, wherein different types of users are provided different levels of access at the user interface.

15. The system of claim 11, wherein the documentation routine comprises at least one of a question-to-data-field linking tool and a keyword search tool.

16. The system of claim 11, wherein the analysis routine compares the data to other data stored in the database and to one or more thresholds.

17. The system of claim 11, wherein the analysis routine determines whether a clinical trial should be certified.

18. The system of claim 11, wherein the analysis routine further comprises an alert tool to generate an alert if the analysis routine determines a health or safety risk, that intervention is needed, or that a study protocol should be changed.

19. The system of claim 11, wherein the analysis routine analyzes the data using at least one of a computer-based trending tool, a computer-based site-to-site variation tool, and a computer-based outlier tool.

20. A computer-implemented data collection and analysis method for managing clinical trial data, comprising, while the clinical trial is ongoing:
automatically contacting a study participant at a scheduled time;
asking the study participant one or more questions;
determining whether the one or more questions have been answered adequately, and if not, asking the study participant one or more follow up questions;
determining whether all scheduled study participants have been contacted, and if not, contacting a next study participant;
recording data received from contacting the clinical trial participant, the data comprising the participant's answers to the one or more questions;
associating the data with one or more study categories, the study categories related to one or more of study protocols, intervention data, compliance data, and demographic data;
storing the data in a searchable database as non-transitory computer readable media; and
comparing the data to one or more thresholds or one or more other data entries in the database.

21. The method of claim 20, wherein contacting a study participant is performed using telephone, text, email, or video communication.

22. The method of claim 20, wherein the comparing step is performed independently by an entity that is not administering the clinical trial to participants.

23. The method of claim 20, wherein the comparing step is performed using at least one of a computer-based trending tool, a computer-based site-to-site variation tool, and a computer-based outlier tool
